(19) United States
(12) Patent Application Publication
(10) Pub. No.: US 2020/0269413 A1
(43) Pub. Date: Aug. 27, 2020

(54) TOOL STORAGE DEVICE

(71) Applicant: Christopher Fisher, Newark, DE (US)

(72) Inventor: Christopher Fisher, Newark, DE (US)

(21) Appl. No.: 16/789,939

(22) Filed: Feb. 13, 2020

Related U.S. Application Data
(60) Provisional application No. 62/811,063, filed on Feb. 27, 2019.

(51) Int. Cl. B25H 3/00; B65D 55/14

(52) U.S. Cl. CPC B25H 3/006; B65D 55/14

(57) ABSTRACT

Exemplary embodiments are directed to a tool storage device including first and second components. The first component includes a body with a hollow interior area, a top surface, and a bottom surface. The first component includes a cutout formed in the body. The second component includes a body with a hollow interior area, a top surface, and a bottom surface. The second component includes a cutout formed in the body. The first component is configured to receive at least a portion of a tool within the hollow interior area. The second component is configured to be concentrically positioned within the interior area of the first component to align the cutouts of the first and second components and cover at least a portion of a tool.

### CROSS-REFERENCE TO RELATED APPLICATIONS

This application claims the benefit of co-pending U.S. Provisional Patent Application No. 62/811,063, which was filed on Feb. 27, 2019. The entire content of the foregoing provisional patent application is incorporated herein by reference.

### TECHNICAL FIELD

The present disclosure relates to a tool storage device and, in particular, to a tool storage device providing a means for safely maintaining a tool while not in use.

### BACKGROUND

Tools, including power tools, are generally stored in a toolbox, hung on a wall, or left in the open when not in use. Such storage can result in a hazardous situation, because the tool is readily accessible and use of the tool by certain individuals cannot be prevented. For example, children may be able to access the tool while a parent is away.

Thus, a need exists for a tool storage device that provides convenient access to the tool by the intended user, while preventing undesired use of the tool. These and other needs are addressed by the tool storage device of the present disclosure.

### SUMMARY

In accordance with embodiments of the present disclosure, an exemplary tool storage device is provided. The tool storage device includes first and second components. The first component includes a body with a hollow interior area, a top surface, and a bottom surface. The first component includes a cutout formed in the body. The second component includes a body with a hollow interior area, a top surface, and a bottom surface. The second component includes a cutout formed in the body. The first component is configured to receive at least a portion of a tool within the hollow interior area. The second component is configured to be concentrically positioned within the interior area of the first component to align the cutouts of the first and second components.

The cutout of the first component is configured and dimensioned to receive therethrough at least a portion of the tool. The second component concentrically positioned within the interior area of the first component is configured to cover at least a portion of the tool received by the first component. In some embodiments, the body of each of the first and second components defines a cylindrical configuration. In some embodiments, the cutout of the first component extends from the top surface downwardly towards the bottom surface a partial length of the body of the first component. In some embodiments, the cutout of the first component extends from an outer surface of the body into the interior area of the first component. In some embodiments, the cutout of the second component extends from the bottom surface upwardly towards the top surface a partial length of the body of the second component. In some embodiments, the cutout of the second component extends from an outer surface of the body into the interior area of the second component.

The first component includes a protrusion extending upwardly from the top surface, and the second component includes a protrusion extending upwardly from the top surface. The protrusion of the first component is radially offset from the cutout of the first component by about 180°, and the protrusion of the second component is radially offset from the cutout of the second component by about 180°. The protrusions of the first and second components each include an aperture, the protrusions configured to be aligned with each other to receive a locking element through the apertures. In the concentric position of the second component disposed within the first component, the top surfaces of the first and second components can be substantially aligned.

In accordance with embodiments of the present disclosure, an exemplary tool storage device is provided. The tool storage device includes a component including a body with a hollow interior area, a top surface, and a bottom surface. The component includes a cutout formed in the body and extending from the top surface downwardly towards the bottom surface a partial length of the body. The component includes a protrusion extending upwardly from the top surface. The hollow interior area is configured and dimensioned to receive at least a portion of a tool. The cutout is configured and dimensioned to receive therethrough at least a portion of the tool.

The cutout extends from an outer surface of the body into the interior area. The cutout extends in a direction away from the protrusion. The protrusion is radially offset from the cutout by about 180°. The protrusion includes an aperture configured to receive a fastener therethrough for mounting the tool storage device to a structure.

In accordance with embodiments of the present disclosure, an exemplary method of storing a tool is provided. The method includes placing at least a portion of the tool within a hollow interior area of a body of a first component of a tool storage device. The first component includes a top surface, a bottom surface, and a cutout formed in the body of the first component. The method includes sliding the tool through the cutout formed in the body of the first component. The method includes aligning a cutout of a second component of the tool storage device with the cutout of the first component. The second component includes a body with a hollow interior area, a top surface, a bottom surface, and the cutout formed in the body of the second component. The method includes concentrically positioning the second component into the hollow interior area of the first component to cover at least a portion of the tool.

In some embodiments, the first component includes a protrusion extending upwardly from the top surface, and the second component includes a protrusion extending upwardly from the top surface. In such embodiments, the method includes aligning the protrusions of the first and second components relative to each other. In such embodiments, the method includes passing a locking element through an aperture in each of the protrusions of the first and second components to interlock the first and second components.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed tool storage device, reference is made to the accompanying figures, wherein:

FIG. 1 is a front view of a first component of an exemplary tool storage device according to the present disclosure.

FIG. 2 is a side view of a first component of an exemplary tool storage device according to the present disclosure.

FIG. 3 is a top view of a first component of an exemplary tool storage device according to the present disclosure.

FIG. 4 is a front view of a second component of an exemplary tool storage device according to the present disclosure.

FIG. 5 is a side view of a second component of an exemplary tool storage device according to the present disclosure.

FIG. 6 is a top view of a second component of an exemplary tool storage device according to the present disclosure.

FIG. 7 is a perspective view of an exemplary tool storage device and a power tool according to the present disclosure.

FIG. 8 is a perspective view of a power tool inserted into a first component of an exemplary tool storage device according to the present disclosure.

FIG. 9 is a perspective view of a power tool inserted into a first component of an exemplary tool storage device, and a second component of the exemplary tool storage device inserted into the first component and over the power tool, according to the present disclosure.

FIG. 10 is a perspective view of a locking element engaged with an exemplary tool storage device according to the present disclosure.

### DESCRIPTION OF EXEMPLARY EMBODIMENTS

In accordance with embodiments of the present disclosure, an exemplary tool storage device is provided that allows for convenient access to the tool when needed for use, and allows for storage/locking of the tool during non-use in a safe manner. In particular, the tool storage device includes two components that surround at least a portion of the tool and interlock together to prevent use of the tool. Upon disengagement of the second component from the first component, the tool can be removed from the first component for use.

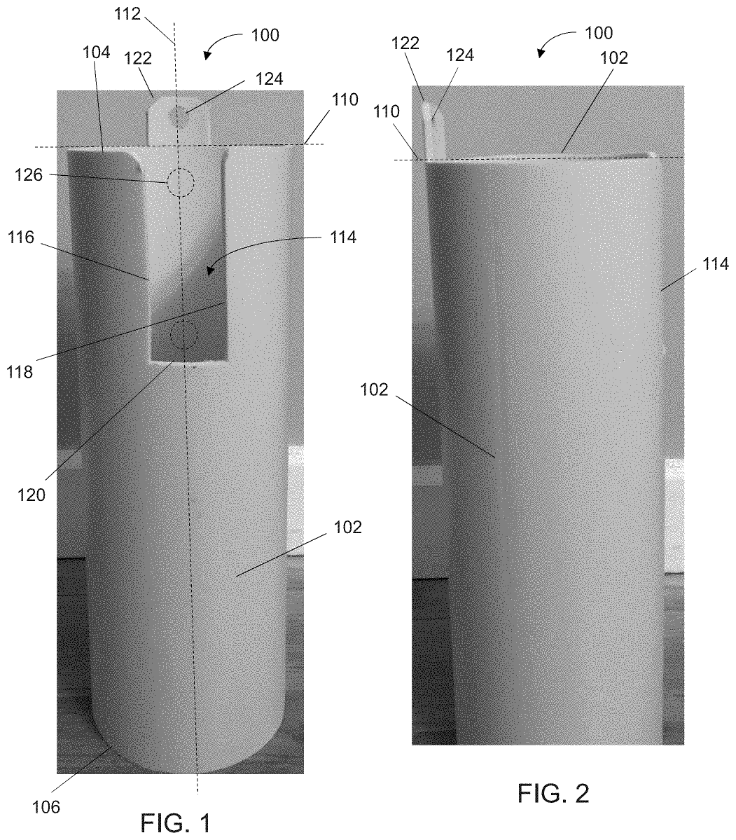

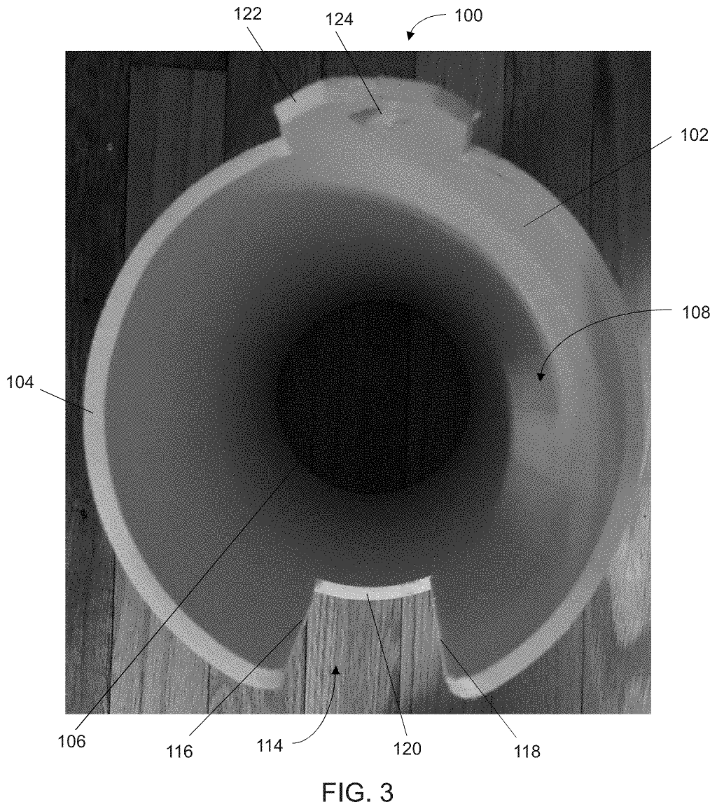

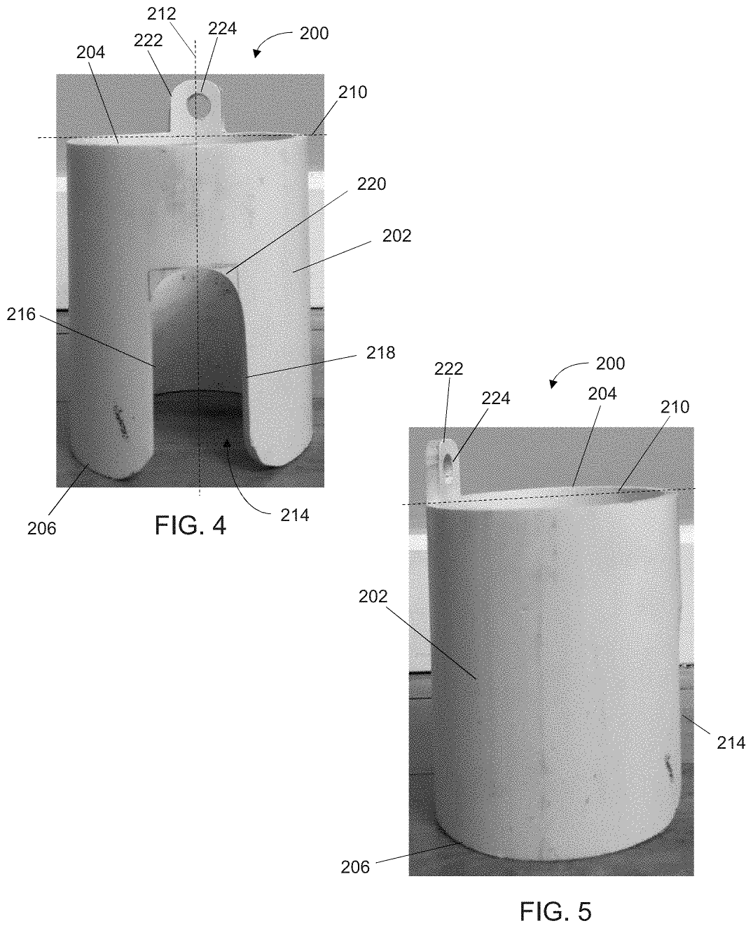

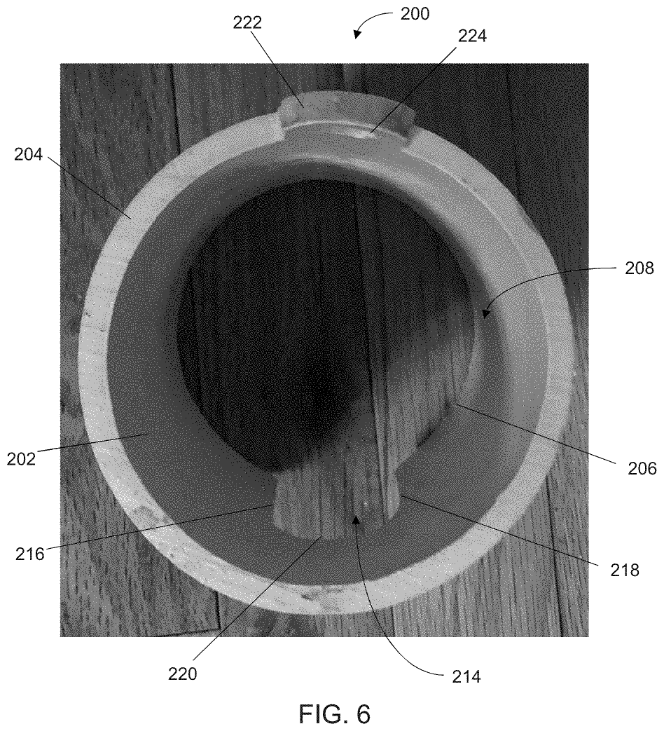

FIGS. 1-3 provide front, side and top views of a first component 100 of an exemplary tool storage device. As will be discussed in greater detail below, the first component 100 can be interlocked with a second component 200 (see, e.g., FIGS. 4-6) to form in combination the tool storage device 300 (see, e.g., FIGS. 5-8). The first and second components 100, 200 can be fabricated from, e.g., plastic, metal, wood, aluminum, composite, combinations thereof, or the like, and can form bottom and top components of the tool storage device 300, respectively. The first component 100 includes a body 102 having top and bottom surfaces 104, 106 on opposing sides from each other. The top and bottom surfaces 104, 106 can be substantially parallel to each other. The body 102 can be substantially hollow, forming an interior area 108. Although depicted as substantially cylindrical in configuration, it should be understood that the tubular configuration of the body 102 can be, e.g., circular, oval, rectangular, square, or the like. Although depicted as having an open bottom surface 106, in some embodiments, the body 102 can include a cap or solid surface covering the opening and interior area 108 at the bottom surface 106.

The height of the cylindrical body 102 of the first component 100 can be measured as a distance between the top and bottom surfaces 104, 106. In some embodiments, the height of the body 102 can be about, e.g., 5 to 24 inches, 6 to 23 inches, 7 to 22 inches, 8 to 21 inches, 9 to 20 inches, 10 to 19 inches, 11 to 17 inches, 12 to 16 inches, 10 to 20 inches, 12 to 18 inches, or the like. In some embodiments, the height of the body 102 can be about, e.g., 5 inches, 6, inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or the like. In some embodiments, the height of the body 102 can be about 16 inches.

In some embodiments, an inner diameter of the body 102 (as measured between inner walls of the body 102) can be about, e.g., 3 to 12 inches, 4 to 11 inches, 5 to 10 inches, 6 to 9 inches, 7 to 8 inches, 5 to 8 inches, or the like. In some embodiments, the inner diameter of the body 102 can be about, e.g., 3 inches, 4 inches, 5 inches, 6 inches, 7 inches, 8 inches, 9 inches, 10 inches, 11 inches, 12 inches, or the like. In some embodiments, the inner diameter of the body 102 can be about 4 9/16 inches.

In some embodiments, an inner perimeter circumference of the body 102 (as measured along the inner wall of the body 102) can be about, e.g., 6 to 24 inches, 7 to 23 inches, 8 to 22 inches, 9 to 21 inches, 10 to 20 inches, 11 to 19 inches, 12 to 18 inches, 13 to 17 inches, 14 to 16 inches, 8 to 20 inches, 10 to 18 inches, or the like. In some embodiments, the inner perimeter circumference of the body 102 can be about, e.g., 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or the like. In some embodiments, the inner perimeter circumference of the body can be about 14⅛ inches.

In some embodiments, a wall thickness of the body 102 (as measured between inner and outer walls of the body 102) can be about, e.g., 1/16 to ½ inch, ⅛ to about 7/16 inch, 3/16 to about ⅜ inch, ¼ to about 5/16 inch, ⅛ to about ⅜ inch, or the like. In some embodiments, the wall thickness of the body 102 can be about, e.g., 1/16 inch, ⅛ inch, 3/16 inch, ¼ inch, 5/16 inch, ⅜ inch, 7/16 inch, ½ inch, or the like. In some embodiments, the wall thickness of the body 102 can be about 3/16 inch.

The top surface 104 can define a plane 110 that extends substantially parallel to horizontal. A central longitudinal axis 112 can extend perpendicularly to the plane 110. The first component 100 includes a cutout 114 (e.g., a slot) formed in the body 102. The cutout 114 extends downwardly from the top surface 104 towards the bottom surface 106 a partial length or height of the body 102. The cutout 114 extends substantially parallel to the central longitudinal axis 112, and extends from the outer surface of the body 102 into the interior area 108.

The cutout 114 includes first and second opposing vertical edges 116, 118 and a bottom edge 120. In some embodiments, the connecting corners between the bottom edge 120 and the vertical edges 116, 118 can be chamfered. The vertical edges 116, 118 can extend substantially parallel to the central longitudinal axis 112, and the bottom edge 120 can extend substantially parallel to the plane 110. In some embodiments, the height of the cutout 114 (as measured from the plane 110 to the bottom edge 120) can be about, e.g., 2 to 10 inches, 3 to 9 inches, 4 to 8 inches, 5 to 7 inches, 3 to 8 inches, 4 to 6 inches, or the like. In some embodiments, the height of the cutout 114 can be about, e.g., 2 inches, 3 inches, 4 inches, 5 inches, 6 inches, 7 inches, 8 inches, 9 inches, 10 inches, 11 inches, 12 inches, or the like. In some embodiments, the height of the cutout 114 can be about 4⅛ inches.

In some embodiments, a width of the cutout 114 (as measured between side walls of the cutout 114) can be about, e.g., ½ to 5 inches, 1 to 4 inches, 2 to 3 inches, or the like. In some embodiments, the width of the cutout 114 can be about, e.g., ½ inch, 1 inch, 2 inches, 3 inches, 4 inches, 5 inches, or the like. In some embodiments, the width of the cutout 114 can be about 1⅝ inches. In some embodiments, the width of the cutout 114 can be substantially uniform along the entire height of the cutout 114. Although depicted as substantially rectangular in shape, the cutout 114 can be of any configuration. In some embodiments, the cutout 114 can be substantially U-shaped. It should be understood that the dimensions and/or configurations of the first component 100 discussed herein can be varied based on the type of tool to be stored in the tool storage device 300.

The first component 100 includes a tab or protrusion 122 extending perpendicularly from the top surface 104. The protrusion 122 is radially offset from the cutout 114 by about 180°, thereby being positioned directly opposite from the cutout 114 and extends upwardly away from the cutout 114. When viewed from the front (e.g., FIG. 1), the cutout 114 and protrusion 122 can substantially align along the central vertical axis 112. The protrusion 122 includes an aperture 124 formed therein. In some embodiments, the protrusion 122 can define a height (as measured from the top surface 104 to the top edge of the protrusion 122) of about, e.g., ½ to 2½ inches, ¾ to 2¼ inches, 1 to 2 inches, 1¼ to 1¾ inches, ½ to 1½ inches, or the like. In some embodiments, the height of the protrusion 122 can be about, e.g., ½ inch, ¾ inch, 1 inch, 1¼ inches, 1½ inches, 1¾ inches, 2 inches, 2¼ inches, 2½ inches, or the like. In some embodiments, the height of the protrusion 122 can be about 1 inch.

In some embodiments, the protrusion 122 can define a width (as measured between side walls of the protrusion 122) of about, e.g., ½ to 2½ inches, ¾ to 2¼ inches, 1 to 2 inches, 1¼ to 1¾ inches, ½ to 1½ inches, or the like. In some embodiments, the width of the protrusion 122 can be about, e.g., ½ inch, ¾ inch, 1 inch, 1¼ inches, 1½ inches, 1¾ inches, 2 inches, 2¼ inches, 2½ inches, or the like. In some embodiments, the width of the protrusion 122 can be about 1⅝ inches.

In some embodiments, the aperture 124 can define a diameter of about, e.g., ¼ to 1 inch, ½ to ¾ inch, ¼ to ¾ inch, or the like. In some embodiments, the diameter of the aperture 124 can be about, e.g., ¼ inch, ½ inch, ¾ inch, 1 inch, or the like. In some embodiments, one or more apertures 126 can be drilled or formed in the first component 100 to allow for mounting of the first component 100 to a structure (e.g., a wall). The cutout 114 provides clearance for drilling holes in the desired position of the first component 100. In some embodiments, two apertures 126 (as shown in FIG. 1) can be pre-formed in the first component 100.

FIGS. 4-6 provide front, side and top views of the second component 200 of the tool storage device 300. The second component 200 includes a body 202 having top and bottom surfaces 204, 206 on opposing sides from each other. The diameter or dimensions of the body 202 can be slightly smaller than the diameter or dimensions of the body 102 of the first component 100 such that that second component 200 can be concentrically positioned within the interior area 108 of the first component 100. It should be understood that the configuration of the second component 200 can be complementary to the configuration of the first component 100 (e.g., circular, oval, rectangular, square, or the like), allowing for the concentric assembly of the components 100, 200. The body 202 can be substantially hollow, forming an interior area 208.

The height of the body 202 of the second component 200 can be measured as a distance between the top and bottom surfaces 204, 206. In some embodiments, the height of the body 202 can be about, e.g., 2 to 12 inches, 3 to 11 inches, 4 to 10 inches, 5 to 9 inches, 6 to 8 inches, 4 to 8 inches, or the like. In some embodiments, the height of the body 202 can be about, e.g., 2 inches, 3 inches, 4 inches, 5 inches, 6 inches, 7 inches, 8 inches, 9 inches, 10 inches, 11 inches, 12 inches, or the like. In some embodiments, the height of the body 202 can be about 5½ inches.

In some embodiments, an outer diameter of the body 202 (as measured between outer walls of the body 202) can be about, e.g., 3 to 12 inches, 4 to 11 inches, 5 to 10 inches, 6 to 9 inches, 7 to 8 inches, 4 to 8 inches, or the like. In some embodiments, the outer diameter of the body 202 can be about, e.g., 3 inches, 4 inches, 5 inches, 6 inches, 7 inches, 8 inches, 9 inches, 10 inches, 11 inches, 12 inches, or the like. In some embodiments, the outer diameter of the body 202 can be about 4⅜ inches.

In some embodiments, an inner perimeter circumference of the body 202 (as measured along the outer wall of the body 202) can be about, e.g., 6 to 24 inches, 7 to 23 inches, 8 to 22 inches, 9 to 21 inches, 10 to 20 inches, 11 to 19 inches, 12 to 18 inches, 13 to 17 inches, 14 to 16 inches, 8 to 20 inches, 10 to 18 inches, or the like. In some embodiments, the outer perimeter circumference of the body 202 can be about, e.g., 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or the like. In some embodiments, the outer perimeter circumference of the body 202 can be about 14 1/16 inches.

In some embodiments, a wall thickness of the body 202 (as measured between inner and outer walls of the body 202) can be about, e.g., 1/16 to ½ inch, ⅛ to about 7/16 inch, 3/16 to about ⅜ inch, ¼ to about 5/16 inch, ⅛ to about ⅜ inch, or the like. In some embodiments, the wall thickness of the body 202 can be about, e.g., 1/16 inch, ⅛ inch, 3/16 inch, ¼ inch, 5/16 inch, ⅜ inch, 7/16 inch, ½ inch, or the like. In some embodiments, the wall thickness of the body 202 can be about 3/16 inches. The top surface 204 can define a plane 210 that extends substantially parallel to horizontal. A central longitudinal axis 212 can extend perpendicularly to the plane 210. The second component 200 includes a cutout 214 (e.g., a slot) formed in the body 202. The cutout 214 extends upwardly from the bottom surface 206 towards the top surface 204 a partial length or height of the body 202. The length or height of the cutout 214 can be dimensioned smaller than the length or height of the cutout 114 of the first component 100.

In some embodiments, the height of the cutout 214 (as measured from the top edge 220 to the bottom surface 206) can be about, e.g., 1 to 6 inches, 2 to 5 inches, 3 to 4 inches, 2 to 4 inches, or the like. In some embodiments, the height of the cutout 214 can be about, e.g., 1 inch, 2 inches, 3 inches, 4 inches, 5 inches, 6 inches, or the like. In some embodiments, the height of the cutout 214 can be about 3½ inches. In some embodiments, a width of the cutout 214 (as measured between side walls of the cutout 214) can be about, e.g., ½ to 5 inches, 1 to 4 inches, 2 to 3 inches, or the like. In some embodiments, the width of the cutout 214 can be about, e.g., ½ inch, 1 inch, 2 inches, 3 inches, 4 inches, 5 inches, or the like. In some embodiments, the width of the cutout 214 can be about 1⅝ inches. In some embodiments, the width of the cutout 214 can be substantially uniform along the entire height of the cutout 214.

The cutout 214 extends substantially parallel to the central longitudinal axis 212, and extends from the outer surface of the body 202 into the interior area 208. The cutout 214 includes first and second vertical edges 216, 218 and a top edge 220. In some embodiments, the connecting corners between the bottom edge 220 and the vertical edges 216, 218 can be chamfered. The vertical edges 216, 218 can extend substantially parallel to the central longitudinal axis 212, and the top edge 220 can extend substantially parallel to the plane 210. Although depicted as substantially U-shaped, the cutout 214 can be of any configuration. In some embodiments, the cutout 214 can be substantially rectangular (e.g., similar to the cutout 114 of the first component 100). It should be understood that the dimensions and/or configurations of the second component 200 discussed herein can be varied based on the type of tool to be stored in the tool storage device 300.

The second component 200 includes a tab or protrusion 222 extending perpendicularly from the top surface 204. The protrusion 222 is radially offset from the cutout 214 by about 180°, thereby being positioned directly opposite from the cutout 214 and extends upwardly away from the cutout 214. When viewed from the front (e.g., FIG. 4), the cutout 214 and the protrusion 222 can substantially align along the central vertical axis 212. The protrusion 222 includes an aperture 224 formed therein. The height of the protrusion 222 and the location of the aperture 224 as measured from the top surface 204 can be dimensioned complementary to the height of the protrusion 122 and the location of the aperture 124 as measured from the top surface 104 of the first component 100.

In some embodiments, the protrusion 222 can define a height (as measured from the top surface 204 to the top edge of the protrusion 222) of about, e.g., ½ to 2½ inches, ¾ to 2¼ inches, 1 to 2 inches, 1¼ to 1¾ inches, ½ to 1½ inches, or the like. In some embodiments, the height of the protrusion 222 can be about, e.g., ½ inch, ¾ inch, 1 inch, 1¼ inches, 1½ inches, 1¾ inches, 2 inches, 2¼ inches, 2½ inches, or the like. In some embodiments, the height of the protrusion 222 can be about 1 inch.

In some embodiments, the protrusion 222 can define a width (as measured between side walls of the protrusion 222) of about, e.g., ½ to 2½ inches, ¾ to 2¼ inches, 1 to 2 inches, 1¼ to 1¾ inches, ½ to 1½ inches, or the like. In some embodiments, the width of the protrusion 222 can be about, e.g., ½ inch, ¾ inch, 1 inch, 1¼ inches, 1½ inches, 1¾ inches, 2 inches, 2¼ inches, 2½ inches, or the like. In some embodiments, the width of the protrusion 222 can be about 1⅝ inches. In some embodiments, the aperture 224 can define a diameter of about, e.g., ¼ to 1 inch, ½ to ¾ inch, ¼ to ¾ inch, or the like. In some embodiments, the diameter of the aperture 224 can be about, e.g., ¼ inch, ½ inch, ¾ inch, 1 inch, or the like.

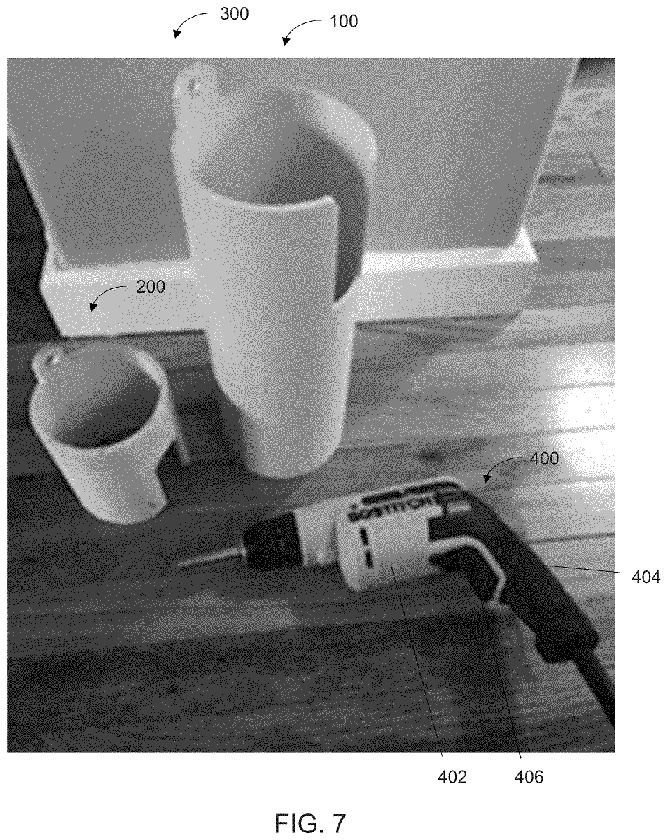

FIG. 7 is a perspective view of the exemplary tool storage device 300 in the form of the first and second components 100, 200, prior to use with a power tool 400. Although the drill is used as an example of a power tool 400 herein, it should be understood that the tool storage device 300 can be used with any type of tool having a substantially “gun-shaped” configuration. For example, tools having a substantially 90° angle between the handle 404 and front section 402 of the tool can be stored in the tool storage device 300. In some embodiments, tools having an angle in the range of about 25° to about 125° can be stored in the tool storage device 300. The tool 400 generally includes a front section 402, a handle 404, and a trigger 406. The dimensions of the first and second components 100, 200 can also be selected based on the dimensions of the power tool 400 to be positioned within the tool storage device 300. In some embodiments, two or more power tools 400 can be stored within a single tool storage device 300, with the first and second components 100, 200 dimensioned to accommodate two power tools 400. Although discussed herein as used for storage of power tools, it should be understood that non-powered tools can also be stored in the tool storage device 300.

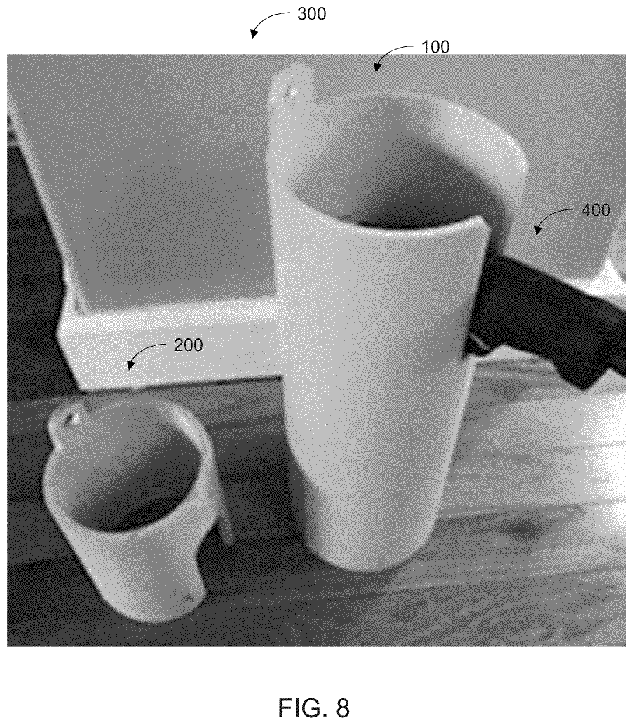

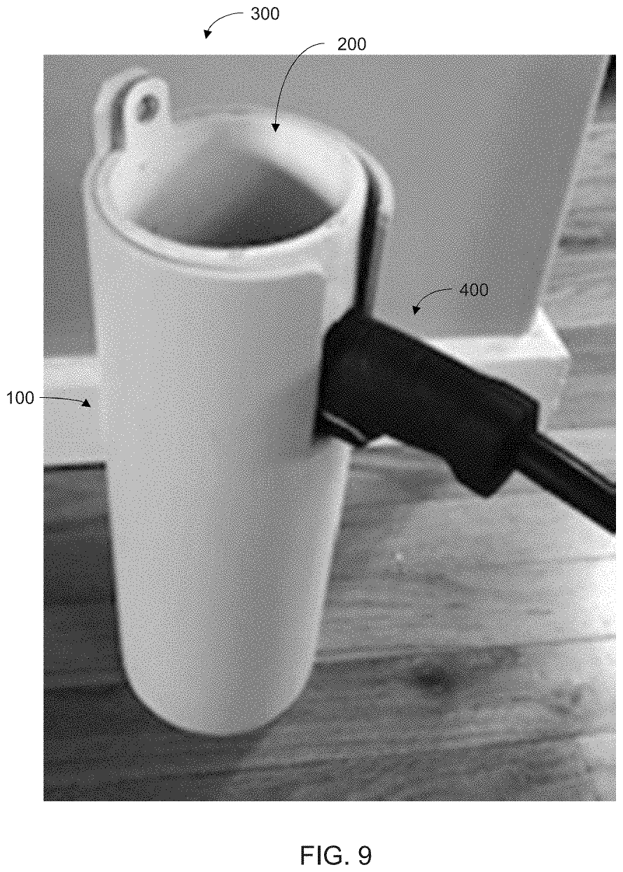

FIG. 8 shows a first step in storing the tool 400 in the tool storage device 300. The front section 402 of the tool 400 is positioned within the interior area 108 of the first component, with the handle 404 of the tool 400 slid downward along the cutout 114 until the handle 404 abuts the bottom edge 120. The dimensions of the cutout 114 can prevent significant lateral or radial movement of the tool 400 within the first component 100. The front section 402 of the tool 400 is entirely surrounded or encased by the first component 100, preventing access to potentially sharp sections of the tool 400. In some embodiments, the trigger 406 of the tool 400 can also be disposed within the interior area 108 of the first component 100, thereby preventing access to the trigger 406 during storage. However, it should be understood that even if the trigger 406 of the tool 400 is exposed during storage, the front section 402 is completely encased within the first component 100, ensuring that actuation of the trigger 406 prevents accidental damage caused by the tool 400. The handle 404 of the tool 400 remains on the outside of the device 300. In some embodiments, maintaining the handle 404 of the tool 400 outside of the device 300 (rather than the entire tool 400 disposed within the device 300) allows the user to visually identify which tool 400 is stored within the device 300.

FIG. 9 shows a second step in storing the tool 400 in the tool storage device 300. The cutout 214 of the second component 200 is aligned with the cutout 114 of the first component 100, and the second component 200 is concentrically inserted into the first component 100. During concentric positioning of the second component 200 within the first component 100, the cutout 214 receives the opposing end of the handle 404 of the tool 400, with the second component 200 slid downward until the handle 404 abuts the top edge 220. The cutouts 114, 214 of the first and second components 100, 200 are thereby aligned relative to each other. The handle 404 of the tool 400 is positioned directly between the bottom edge 120 and the top edge 220 of the cutouts 114, 214. In some embodiments, the first component 100 concentrically receives at least a portion of the second component 200. In some embodiments, the first component 100 concentrically receives the entire structure of the second component 200 (except of the protrusion 222) such that the top surfaces 104, 204 are substantially aligned along the same plane 110, 210.

In the assembled configuration shown in FIG. 9, the top surfaces 104, 204 of the first and second components 100, 200 are substantially aligned such that the protrusions 122, 222 and apertures 124, 224 also align relative to each other. The height of one or both cutouts 114, 214 can be selected to accommodate the handle 404 of the tool 400 while ensuring that the top surfaces 104, 204 of the first and second components 100, 200 are aligned. Alignment of the top surfaces 104, 204 ensures alignment of the apertures 124, 224 for interlocking the first and second components 100, 200 relative to each other.

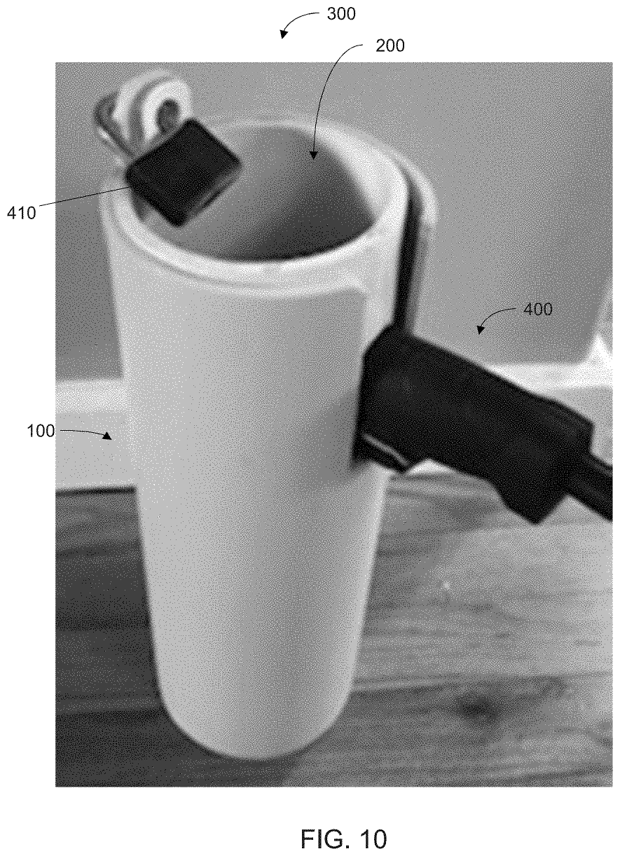

As shown in FIG. 10, a locking element 410 (e.g., a lock, zip tie, or the like) can be passed through the apertures 124, 224 and locked relative to the tool storage device 300. The locking element 410 prevents disengagement of the first and second components 100, 200 from each other (e.g., sliding of the second component 200 upwardly and out of the first component 100), ensuring that the tool 400 remains within the tool storage device 300. When use of the tool 400 is desired, the locking element 410 can be removed, the second component 200 can be slid upwardly out of the second component 200 to completely disengage the second component 200 from the first component 100, and the tool 400 can be slid upwardly out of the first component 100.

The tool storage device 300 provides convenient access to the tool 400, while safely storing the tool 400 during non-use. It should be understood that the tool storage device 300 can be secured to a structure (e.g., a wall) by passing a fastener through an aperture (e.g., aperture(s) 126) formed in the first component 100, and the second component 200 can be engaged with the first component 100 without the use of a locking element 410. For example, due to the top loading of the second component 200 into the first component 100, the tool 400 disposed within the first component 100 (and gravity) can maintain the assembled position of the first and second components 100, 200 without the use of a locking element 410. In some embodiments, the first component 100 can be used without the second component 200 to hang tools 400 on a wall (e.g., if tools are stored in a locked room).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A tool storage device, comprising:
a first component including a body with a hollow interior area, a top surface, and a bottom surface, a cutout formed in the body of the first component; and
a second component including a body with a hollow interior area, a top surface, and a bottom surface, a cutout formed in the body of the second component;
wherein the first component is configured to receive at least a portion of a tool within the hollow interior area; and
wherein the second component is configured to be concentrically positioned within the interior area of the first component to align the cutouts of the first and second components.

2. The tool storage device of claim 1, wherein the cutout of the first component is configured and dimensioned to receive therethrough at least a portion of a tool, and wherein the second component concentrically positioned within the interior area of the first component is configured to cover at least a portion of the tool.

3. The tool storage device of claim 1, wherein the body of each of the first and second components defines a cylindrical configuration.

4. The tool storage device of claim 1, wherein the cutout of the first component extends from the top surface downwardly towards the bottom surface a partial length of the body of the first component.

5. The tool storage device of claim 4, wherein the cutout of the first component extends from an outer surface of the body into the interior area of the first component.

6. The tool storage device of claim 1, wherein the cutout of the second component extends from the bottom surface upwardly towards the top surface a partial length of the body of the second component.

7. The tool storage device of claim 6, wherein the cutout of the second component extends from an outer surface of the body into the interior area of the second component.

8. The tool storage device of claim 1, wherein the first component comprises a protrusion extending upwardly from the top surface, and the second component comprises a protrusion extending upwardly from the top surface.

9. The tool storage device of claim 8, wherein the protrusion of the first component is radially offset from the cutout of the first component by about 180°, and the protrusion of the second component is radially offset from the cutout of the second component by about 180°.

10. The tool storage device of claim 8, wherein the protrusions of the first and second components each include an aperture, the protrusions configured to be aligned with each other to receive a locking element through the apertures.

11. The tool storage device of claim 1, wherein in the concentric position of the second component within the first component, the top surfaces of the first and second components are substantially aligned.

12. A tool storage device, comprising:
a component including a body with a hollow interior area, a top surface, and a bottom surface, a cutout formed in the body of the component and extending from the top surface downwardly towards the bottom surface a partial length of the body, and a protrusion extending upwardly from the top surface;
wherein the hollow interior area is configured and dimensioned to receive at least a portion of a tool; and
wherein the cutout is configured and dimensioned to receive therethrough at least a portion of the tool.

13. The tool storage device of claim 12, wherein the cutout extends from an outer surface of the body into the interior area.

14. The tool storage device of claim 12, wherein the cutout extends in a direction away from the protrusion.

15. The tool storage device of claim 12, wherein the protrusion is radially offset from the cutout by about 180°.

16. The tool storage device of claim 12, wherein the protrusion includes an aperture configured to receive a fastener therethrough for mounting the tool storage device to a structure.

17. A method of storing a tool, comprising:
placing at least a portion of the tool within a hollow interior area of a body of a first component of a tool storage device, the first component including a top surface, a bottom surface, and a cutout formed in the body of the first component;
sliding the tool through the cutout formed in the body of the first component;
aligning a cutout of a second component of the tool storage device with the cutout of the first component, the second component including a body with a hollow interior area, a top surface, a bottom surface, and the cutout formed in the body of the second component; and
concentrically positioning the second component into the hollow interior area of the first component to cover at least a portion of the tool.

18. The method of claim 17, wherein the first component comprises a protrusion extending upwardly from the top surface, and the second component comprises a protrusion extending upwardly from the top surface.

19. The method of claim 18, comprising aligning the protrusions of the first and second components relative to each other.

20. The method of claim 19, passing a locking element through an aperture in each of the protrusions of the first and second components to interlock the first and second components.
